(19) United States
(12) Patent Application Publication
(10) Pub. No.: US 2025/0287939 A1
(43) Pub. Date: Sep. 18, 2025

(54) INCORPORATED INSECTICIDAL COMPOSITION IN POLYMER MATRIX

(71) Applicant: ANAND SAMIAPPAN

(72) Inventor: ANAND SAMIAPPAN

(73) Assignee: V.K.A. Polymers Private Limited, Karur (IN)

(21) Appl. No.: 18/607,439

(22) Filed: Mar. 16, 2024

(51) Int. Cl. A01N 25/10; A01N 43/30; A01N 43/36; A01N 53/00; A01P 7/04

(52) U.S. Cl. CPC A01N 25/10; A01N 43/30; A01N 43/36; A01N 53/00; A01P 7/04

(57) ABSTRACT

The present invention relates to an incorporated insecticidal composition in polymer matrix, which is a combination of active substances, including pyrethroid and pyrrole, and optionally an organic synergist that is capable of being incorporated in a polymer substrate. The present invention also relates to a method of incorporating the insecticidal composition of the present invention in polymer matrix useful for making insect/pests protective nets or insecticide treated nets (ITNs) or long lasting insecticidal net (LLIN).

### FIELD OF THE INVENTION

The present invention relates to an incorporated insecticidal composition in a polymer matrix and a method of incorporating the same into a substrate.

More particularly, the present invention relates to an insecticidal composition incorporated in the polymer matrix useful for making Insecticidal treated Nets (ITN) or long lasting insecticidal net (LLIN).

### BACKGROUND OF THE INVENTION

A vector is an organism capable of transmitting infectious agents between humans or from animals to humans. Vector-borne diseases are caused by parasites, viruses, and bacteria spread by vectors. Vector control, which is highly effective in preventing infection and reducing disease transmission, is an essential component of malaria control and elimination strategies. Conventional vector control methods include insecticidal sprays, mosquito coils to repel mosquito, mosquito ovitraps etc.

However, all insect species that are major human disease vectors have developed insecticide resistance. Furthermore, insecticidal sprays and coils often cause throat irritation and difficulty breathing in people with respiratory problems.

Due to the limitations of traditional insecticide-based strategies, particularly the development of insecticide resistance, significant efforts have been made to develop alternative eco-friendly methods such as long-lasting insecticidal nets (LLINs).

LLINs are mosquito nets that have the insecticide incorporated into the fiber and are generally more effective than conventional insecticide treated nets (ITNs) because they have an even and quality controlled insecticide application. Furthermore, because it can be used for 3-5 years, LLIN is more cost-effective than distributing conventional bed nets and treating them with insecticide once or twice a year. These are an essential malaria prevention tool that is widely used. Long Lasting Insecticidal nets (LLINs) provide better and more effective protection by repelling and killing mosquitoes.

Joachim et al in US20210355139A1 discloses insecticidal methods, uses and applications of pyrimidinium compounds, their stereoisomers, salts, tautomers and N-oxides, and/or compositions containing such compounds for controlling invertebrate pests. Said invention also relates to mixtures of these compounds with other active ingredients, which synergistically enhances the effect of pesticidal composition.

Chongqing et al in CN106676661A pertains to a protection net, more specifically to a long-lasting insect and bird preventing fiber protection net and its method of manufacturing. The long-lasting insect and bird repellent fiber protection net comprises of the following components in weight order: 60-80 parts polypropylene, 2-10 parts melamine-formaldehyde resin, 10-20 parts a modified monomer, 1-5 parts of an antioxidant, 1-3 parts permethrin, and 2-5 parts deltamethrin.

Mikkel Vestergaard et al in US2019037846A1 discloses an insecticidal polymer matrix containing piperonyl butoxide (PBO) and deltamethrin (DM), wherein the ratio of PBO to DM content by weight is greater than 3.

Matthieu Zellweger et al in WO2011124227A1 discloses a method of providing long-term stability to alkali-sensitive biocides in polypropylene products by incorporating biocides such as deltamethrin with acid into a polymer matrix comprising polypropylene. An article comprising a thermoplastic polypropylene polymer matrix having a biocide and an acid dispersed throughout the polymer matrix. The article is a multifilament yarn from which can be used for preparing mosquito nets.

Despite plethora of literature and known numerous pesticide compounds and their compositions belonging to various chemical classes have been developed and utilized, excessive use of these have resulted in the insecticide resistance with due course of time. Therefore, there is a growing need for new, cost-effective, safe and reliable methods of controlling vectors like insects and mosquitoes that alleviates the above mentioned drawbacks in the purview of cited prior art.

### OBJECT OF THE INVENTION

The main object of the present invention is to provide an insecticidal composition that is a combination of an active substance and a synergist and is incorporated in a substrate.

Another object of the present invention is to provide a method of incorporation said insecticidal composition on a substrate that is a long lasting insecticidal net (LLIN).

Still another object of the present invention is to provide an insecticidal composition incorporated in a substrate that is effective on mosquitoes and disease carrying vectors.

### SUMMARY OF THE INVENTION

The present invention relates to an incorporated insecticidal composition in polymer matrix comprising of a pyrethroid insecticide, a pyrrole chemical entity and/or optionally an organic synergist effective for controlling insects/pests and disease carrying vectors. During it efficacy testing, it is found very effective against susceptible and synthetic pyrethroid resistant strains of malaria causing vectors.

Said insecticidal composition in polymer matrix is useful for making insect/pests Protective nets or insecticide treated nets (ITNs) or long lasting insecticidal net (LLIN).

The present invention also relates to a method of incorporating the insecticidal composition in polymer matrix comprising the steps—
a. Mixing the pyrethroid insecticide, a pyrrole entity and an organic synergist each individually or in combination in the polymer matrix in the melt stage in twin screw compounding extruder;
b. Recovering the master batch granules incorporated with insecticide composition;
c. Testing the master batch for incorporated insecticide content, wherein the concentration of pyrethroid insecticide is in range of 5% to 20% w/w, the concentration of pyrrole insecticide as Chlorfenapyr is in the range of 5% to 20% w/w and the concentration of organic synergist as Piperonyl butoxide is in the range of 0% to 10% w/w.

The method of incorporating insecticide in the step a. further comprising mixing insecticide optionally with adjuvant selected from antioxidants, UV Stabilizers/absorbers, processing aids, coloring agents, release agents, lubricants, surfactants, antistatic agents and viscosity modifiers or adjuvant can be incorporated within polymer matrix separately without combining with insecticide/s.

The above objects and advantages of the present invention will become apparent from the hereinafter set forth detailed description and working examples of the invention described herein below.

### DESCRIPTION OF THE INVENTION

The present invention will now be described hereinafter with reference to the accompanying data in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

The present invention now will be described hereinafter with reference to the detailed description, in which some, but not all embodiments of the invention are indicated. Indeed, the invention may be embodied in many different forms and should not be construed as limited to the embodiments set forth herein; rather, these embodiments are provided so that this disclosure will satisfy applicable legal requirements. Like numbers refer to like elements throughout. The present invention is described fully herein with non-limiting embodiments and exemplary experimentation.

The embodiments of the present invention provides an incorporated insecticidal composition in polymer matrix comprising of a pyrethroid insecticide, a pyrrole chemical entity and/or optionally an organic synergist effective for controlling insects/pests and disease carrying vectors.

Said incorporated insecticidal composition in polymer matrix may be useful for making insect/pests protective nets or insecticide treated nets (ITNs) or long lasting insecticidal net (LLIN).

The incorporated insecticidal composition in polymer matrix wherein, polymer matrix used is selected from polyethylene or polypropylene.

The incorporated insecticidal composition in polymer matrix wherein, pyrethroid insecticide is selected from Bifenthrin, λ-Cylohalthrin, α-Cypermethrin or Deltamethrin and said pyrrole chemical entity is Chlorfenapyr and said organic synergist is Piperonyl butoxide.

The pyrethroid is an organic compound that is derived from naturally occurring pyrethrins compounds and is neurotoxin to insects. Pyrethroids target the central nervous system of insects by way of interaction with voltage gated sodium channels in neurons of insects thereby resulting in depolarization, followed by hyper excitation and death of the insects. The pyrrole is an organic chemical compound that acts as an active ingredient in pest control products. Pyrrole affects the energy system of an insect by disrupting the functioning of mitochondria of cells and due to the lack of production of energy, the insects are unable to perform various other functions of the cells thereby leading to the death of the insects. The organic synergist is a chemical that makes an insecticide effective in killing pests. The synergists slow down or inhibit the process of breakdown of pesticide chemical by the insects thereby enabling the insecticide to perform the process of killing of the insects.

The pyrethroid compound is selected from pyrethroids include Bifenthrin, beta Cyfluthrin, Cyfluthrin, Cypermethrin, deltamethrin, Esfenvalerate, lambda-cyhalothrin, gamma cyhalothrin, imiprothrin, prallethrin, resmethrin, tefluthrin, tetramethrin, and tralomethrin. The pyrrole entity is selected as Chlorfenapyr. The synergist is selected as Piperonyl butoxide (PBO).

In another embodiment of the present invention, it provide a method of incorporating the insecticidal composition in polymer matrix comprising the steps—
a. Mixing the pyrethroid insecticide, a pyrrole entity and an organic synergist each individually or in combination in the polymer matrix in the melt stage in twin screw compounding extruder
b. Recovering the master batch granules incorporated with insecticide composition
c. Testing the master batch for incorporated insecticide content, wherein the concentration of pyrethroid insecticide is in range of 5% to 20% w/w, the concentration of pyrrole insecticide as Chlorfenapyr is in the range of 5% to 20% w/w and the concentration of organic synergist as Piperonyl butoxide is in the range of 0% to 10% w/w.

In a particular embodiment for method of incorporating the insecticidal composition in polymer matrix, wherein the step a. method is comprising mixing the pyrethroid insecticide, a pyrrole entity and an organic synergist each individually providing individual master batch granules.

The further embodiment according to the invention for method of incorporating the insecticidal composition in polymer matrix, wherein the step a. comprising mixing insecticide optionally with adjuvant selected from antioxidants, UV Stabilizers/absorbers, processing aids, coloring agents, release agents, lubricants, surfactants, antistatic agents and viscosity modifiers or adjuvant can be incorporated within polymer matrix separately without combining with insecticide/s.

The further embodiment according to the invention for method of incorporating the insecticidal composition in polymer matrix, wherein, step b of recovering master batch granules comprising cutting and flash cooling at temperature ranging between 10-17° C.
In yet further embodiment according to the invention for method of incorporating the insecticidal composition in polymer matrix, wherein the insecticide treated nets (ITNs) or long lasting insecticidal net (LLIN) is produced out by warp knitting from monofilament yarn extruded out of this polymer matrix. In yet further another embodiment according to the invention for method of incorporating the insecticidal composition in polymer matrix, wherein the insecticide incorporated monofilament yarn has thickness ranging between 75 to 250 denier. In more preferred embodiment of the present invention, the incorporated the insecticidal composition in polymer matrix, the monofilament yarn has thickness ranging between 90 to 200 Denier. For more clarity, Denier is a unit of measure for the linear mass density of fibers. It is the mass in grams per 9,000 meters of the fiber. (The denier is based on a natural reference: a single strand of silk is approximately one denier; a 9,000-metre strand of silk weighs about one gram).

Testing the extruded Incorporated monofilament yarn (fabric) incorporated with pyrethroid insecticide and a pyrrole insecticide resulted in concentration of pyrethroid insecticide is in range of 0.01% to 5% w/w, the concentration of pyrrole insecticide as Chlorfenapyr is in the range of 0.01% to 8% w/w and the concentration of organic synergist as Piperonyl butoxide is in the range of 0% to 2% w/w.

In one of the specific embodiment according to the present invention, entire process of making novel insecticidal treated nets (ITN) using incorporated insecticidal composition technology in polyethylene is summarized here below, though it should not construed for its limiting the scope.

The ITN polymeric monofilament fiber material as polyethylene was produced using a Twin-screw-co-rotating close-meshing extruder. The Extruder temperatures were maintained up to 200±5° C. maximum in all steps with extruder speed was about 150±10 rpm.

In the first step, it comprised producing a mixture of 10-20% by weight of technical-grade Bifenthrin with 5-10% by weight of technical Pipronyl butoxide (Mixture-1) and another mixture of 10-15% by weight of technical-grade Chlorfenapyr with 5-10% by weight of technical-grade Piperonyl butoxide (Mixture-2). Thereafter, 20-25% of Mixture-1 and 20-25% of Mixture-2 were each individually combined with 75-80% by weight of Linear Low Density Polyethylene (Grade-20 MFI).

Alternatively, it may also comprised making a mixture of 5-10% by weight of technical-grade Bifenthrin, 5-10% by weight of technical-grade Chlorfenapyr and 80-90% by weight of Linear Low Density Polyethylene (Grade-20 MFI) without involving use of synergist as Piperonyl butoxide.

As synergist-Piperonyl butoxide is in liquid state, inventor of the present application found it preferable to add in two different blends of making the separate master batches. This was observed to safeguard the consistency of uniform quality of master batches, though other suitable ways and means may be utilized to achieve the incorporated composition in polymer matrix.

The polyethylene (LLDPE) used contains the customary adjuvant (or additives) release agents, lubricants, surfactants, antistatic agents and viscosity modifiers.

The above composition materials were introduced in solid and liquid forms into the feed Zone of the twin-screw compounding extruder to produce concentrated master batch of active ingredients. This master batch produced shall be used for the further stages.

This master batch was diluted in a second step to a High Density Polyethylene (HDPE) material containing 0.7% by weight of technical-grade Bifenthrin, 0.8% by weight of technical-grade Chlorfenapyr, 0.6% by weight of technical-grade Piperonyl butoxide and 0.4% by weight of the additive, which may be selected from Stearic acid or polyethylene waxes or oleic acid or silicone based compounds or fluoro-compounds elastomers.

The above produced master batch, 10% by weight is taken and about 90% by weight of HDPE were mixed in a suitable or tumble mixer and this mixture was subjected to extrusion using a close-meshing single-screw monofilament extruder under the above-mentioned conditions.

The polyethylene was supplied to the extruder in pellet form in the feed zone and the additive was dosed as per the desired quantity into the polymer melt the form of concentrated master batch.

The polymeric material of the present invention was used to produce insecticide incorporated monofilament yarn having linear density ranging between 75-250 denier, wherein, the polymeric material was melted in a single-screw extruder with temperature controlled to 200±5° C. and extruded through a suitable monofilament die.

The further embodiment according to the invention for method of incorporating the insecticidal composition in polymer matrix, wherein the incorporation of insecticidal composition is achieved before extrusion process in the direct master batch mixing or molten state of the polymer matrix using side feeder.

The method of incorporation of the insecticidal composition on a substrate, that is LLIN, involves the extrusion process that is performed at high temperatures. The high temperature may disintegrate the active substances of said insecticidal composition, hence, a combination of polymers and processing aids is employed along with a thermoplastic polymer, preferably high density polyethylene. The unique of making incorporated formulation according to present invention is meticulously designed as combination employed in said method maintains the high level of the temperature to a certain limit so that the active substances are retained intact from any disintegration during the master batch and subsequently filament extrusion process.

ITN products (fabric or yarn) derived from novel incorporated insecticidal composition in polyethylene polymer matrix was subjected to their bioefficacy testing for controlling disease carrying vectors as well as safety evaluations.

The products appear to be promising in their activities and intended role of controlling disease carrying vectors with mosquitoes or similar insects.
1. ITN products derived from novel incorporated insecticidal composition in polyethylene polymer matrix are observed to be enough potent and exceeding the WHO threshold criteria for ITNs specifically Blood Feeding Inhibition (BFI) of ≥90% and insects Mortality of ≥80%.
2. ITN products derived from novel incorporated insecticidal composition in polyethylene polymer matrix were found significantly superior compared from existing WHO Prequalified Marketed Product, which is apparently an insecticidal coated but not a polymeric matrix incorporated product. Further, said novel incorporated products has better expectations, since highly toxic/hazardous active insecticide/pesticides unlike WHO Prequalified Marketed polyester coated Product, are not excepted to be present on the surface of fabric (knitted fibers) but present in polymer matrix inside, which not only provides the improved shelf life but also ensure the long term safety from exposure to the user human beings at fields and homes.

In a separate study was also performed independently for understanding the regeneration time after washing following WHO criteria for the ITN products derived from novel incorporated insecticidal composition in polyethylene polymer matrix. Customary tests like Cone Assay and Tunnel tests were performed as per WHO protocol (WHO Threshold criteria of 95% Knock Down in 60 min i.e. KD60 and or 80% 72 hour Mortality for Cone Assay). The result outcomes for these novel ITN products derived from novel incorporated insecticidal composition in polyethylene polymer matrix according to the present invention surprised the finding that all products obtained exceeds the WHO Threshold criteria of for regeneration time.

Certain specific aspects and embodiments of the present application will be explained in more detail with reference to the following examples, which are provided by way of illustration only and should not be construed as limiting the scope of the invention in any manner.

### EXAMPLE 1

### ITN Formulation With Bifenthrin, Chlorfenapyr and Piperonyl Butoxide Incorporated In Polyethylene (A)

The polymeric material as polyethylene was produced using a Twin-screw-co-rotating close-meshing extruder.

The Extruder temperatures were maintained to 200° C. maximum in all steps with extruder speed was about 150 rpm.

In the first step, it comprised producing a mixture of 15% by weight of technical-grade Bifenthrin with 7.5% by weight of technical Piperonyl butoxide (Mixture-1) and another mixture of 15% by weight of technical-grade Chlorfenapyr with 7.5% by weight of technical-grade Piperonyl butoxide (Mixture-2).

Thereafter, 22.5% of Mixture-1 and 22.5% of Mixture-2 were each individually combined with 77.5% by weight of Linear Low Density Polyethylene (Grade-20 MFI). The polyethylene (LLDPE) used contains the customary adjuvant (or additives) selected from antioxidants, UV Stabilizers/absorbers, processing aids, coloring agents, release agents, lubricants, surfactants, antistatic agents and viscosity modifiers.

The above composition materials were introduced in solid and liquid forms into the feed Zone of the twin-screw compounding extruder to produce two concentrated Masterbatches of active ingredients with synergist.

### Master Batch Analysis (by GC)

a) Master batch-1 (Mixture-1): Bifenthrin 15.10% w/w+Piperonyl butoxide (PBO)=7.50% w/w
b) Master batch-2 (Mixture-2): Chlorfenapyr 15.35% w/w+Piperonyl butoxide (PBO)=7.78% w/w

These concentrated masterbatches were diluted in a second step to a High Density Polyethylene (HDPE) material containing 0.7% by weight of technical-grade Bifenthrin, 0.8% by weight of technical-grade Chlorfenapyr, 0.7% by weight of technical-grade Piperonyl butoxide and 0.4% by weight of the additive (Stearic acid).

To this end, 5% by weight of master batch-1, 5% by weight of master batch-2 above and 89.6% by weight of HDPE were mixed in a tumble mixer and this mixture was extruded using a close-meshing single-screw monofilament extruder under the above-mentioned conditions. The polyethylene was supplied to the extruder in pellet form in the feed zone and the additive was dosed as per the desired quantity into the polymer melt the form of concentrated master batch.
Entire extrusion took place under the below mentioned conditions.

The polymeric material of the present invention was used to produce insecticide incorporated monofilament yarn having linear density ranging between 75-250 denier, wherein, the polymeric material was melted in a single-screw extruder with temperature controlled to 200±5° C. and extruded through a suitable monofilament die.

ITN (fabric/yarn) Analysis (By GC): Bifenthrin 0.733% w/w; Chlorfenapyr=0.857% w/w and Piperonyl butoxide (PBO)=0.716% w/w; Linear Density=133 Denier; Fabric weight=35.7 g/m²; Bursting Strength fabric=426.4kPa

### EXAMPLE 2

### ITN Formulation With Bifenthrin and Chlorfenapyr (Without Piperonyl Butoxide) Incorporated in Polyethylene (B)

The ITN incorporated formulation without using Piperonyl butoxide (PBO) in the polyethylene polymeric material was produced using a Twin-screw-co-rotating close-meshing extruder.

The Extruder temperatures were maintained to 200±5° C. maximum in all steps with extruder speed was about 150 rpm.

In the first step, it comprised producing a mixture of 7% by weight of technical-grade Bifenthrin, and 8% by weight of technical-grade Chlorfenapyr and 85% by weight of Linear Low Density Polyethylene (Grade-20 MFI).

The polyethylene (LLDPE) of Grade-20 MFI used contained the customary adjuvant release agents, lubricants, surfactants, antistatic agents and viscosity modifiers.
The above composition materials were introduced in solid forms into the feed zone of the twin-screw compounding extruder to produce concentrated master batch of active ingredients.

Master batch Analysis (By GC): Bifenthrin 7.15% w/w; Chlorfenapyr=8.17% w/w This mixture was diluted in a second step to a High Density Polyethylene (HDPE) material containing 0.7% by weight of technical-grade Bifenthrin, 0.8% by weight of technical-grade Chlorfenapyr and 0.4% by weight of the Stearic acid as lubricant additive.

To this end, 10% by weight of above master batch and 90% by weight of HDPE were mixed in a tumble mixer and this mixture was extruded using a close-meshing single-screw monofilament extruder under the above-mentioned conditions.

The polyethylene was supplied to the extruder in pellet form in the feed zone and the additive was dosed as per the desired quantity in the form of master batch into the polymer melt and Extrusion took place under the below mentioned conditions.

The polymeric material of the present invention was used to produce insecticide incorporated monofilament yarn having linear density ranging between 75-200 denier, wherein, the polymeric material was melted in a single-screw extruder with temperature controlled to 200±5° C. and extruded through a suitable monofilament die.

ITN (fabric/yarn) Analysis (By HPLC): Bifenthrin 0.737% w/w; Chlorfenapyr=0.867% w/w; Linear Density=130.5 Denier; Fabric weight=36 g/m²; Bursting Strength fabric=424 kPa

### EXAMPLE 3

### ITN Formulation With Alpha Cypermethrin, Chlorfenapyr and Piperonyl Butoxide Incorporated in Polyethylene (C)

The ITN incorporated formulation using Alpha Cypermethrin, Chlorfenapyr and Piperonyl butoxide (PBO) in the polyethylene polymeric material was produced using a Twin-screw-co-rotating close-meshing extruder. The Extruder temperatures were maintained to 200±5° C. maximum in all steps with extruder speed was about 150 rpm.

In the first step, it comprised producing a mixture of 13% by weight of technical-grade α-Cypermethrin with 7.5% by weight of technical Piperonyl butoxide (Mixture-1) and another mixture of 15% by weight of technical-grade Chlorfenapyr with 7.5% by weight of technical-grade Piperonyl butoxide (Mixture-2).

Thereafter, 21% of Mixture-1 and 21% of Mixture-2 were each individually combined with 58% by weight of Linear Low Density Polyethylene (Grade-20 MFI).

The polyethylene (LLDPE) used contains the customary adjuvant (or additives) selected from antioxidants, UV Stabilizers/absorbers, processing aids, coloring agents, release agents, lubricants, surfactants, antistatic agents and viscosity modifiers.

The above composition materials were introduced in solid and liquid forms into the feed Zone of the twin-screw compounding extruder to produce two concentrated Masterbatches of active ingredients with synergist.

### Master Batch Analysis (By GC)

a) Master batch-1 (Mixture-1): α-Cypermethrin 13.23% w/w+Piperonyl butoxide (PBO)=7.43% w/w
b) Master batch-2 (Mixture-2): Chlorfenapyr 15.21% w/w+Piperonyl butoxide (PBO)=7.60% w/w

These concentrated masterbatches were diluted in a second step to a High Density Polyethylene (HDPE) material containing 0.6% by weight of technical-grade Alphacypermethrin, 0.8% by weight of technical-grade Chlorfenapyr, 0.7% by weight of technical-grade Piperonyl butoxide and 0.4% by weight of the additive (Stearic acid).

To this about 5% by weight of Master batch-1, 5% by weight of Master batch-2 above and 89.6% by weight of HDPE were mixed in a tumble mixer and this mixture was extruded using a close-meshing single-screw monofilament extruder under the above-mentioned conditions. The polyethylene was supplied to the extruder in pellet form in the feed zone and the additive was dosed as per the desired quantity into the polymer melt the form of concentrated master batch. Entire extrusion took place under the below mentioned conditions.

The polyethylene was supplied to the extruder in pellet form in the feed zone and the additive was dosed as per the desired quantity into the polymer melt the form of concentrated masterbatch. Extrusion took place under the abovementioned conditions.

The polymeric material of the present invention was used to produce insecticide incorporated monofilament yarn having linear density ranging between 75-250 denier, wherein, the polymeric material was melted in a single-screw extruder with temperature controlled to 200+5° C. and extruded through a suitable monofilament die.

ITN (fabric/yarn) Analysis (By GC): Alpha Cypermethrin 0.613% w/w; Chlorfenapyr=0.82% w/w; Piperonyl butoxide=0.705% w/w; Linear Density=131 Denier; Fabric weight=36.4 g/m²; Bursting Strength of fabric=421.6 kPa

### Bioassay Test Protocol and Results

The monofilament yarn obtained as above was warp knitted to make the fabric for performing efficacy test (Bioassay Test) as per WHO test protocol in order to know the performance utility with respect to existing commercial products. WHO Prequalified treated net (ITN) products that are coated with active insecticides, when washed often lead to loss of activity for controlling disease carrying vectors like mosquitoes or similar insects.

Inventor have successfully developed the potent and safe, incorporated Insecticidal Treated Nets (ITNs) and achieved the WHO objective purpose of WHO threshold criteria for ITNs specifically Blood Feeding Inhibition (BFI) of ≥90% and insects Mortality of ≥80%.

A comparative bioefficacy study was performed independently at Tanzania, Ivory Coast, and in India in their GLP (Good Laboratories Practice) compliance facilities, which have concluded that newly developed ITNs as per present invention are much superior and safe in performance even after 20 times Wash—WHO protocol based criteria. Test protocol summary and their results outcomes are summarized herein below in the Tables.

### Washing Protocol: (20 Times Wash (20×)—In-Line With WHO Protocol)

Wherever washing of ITNs is used, they were followed the below ITNs washing protocol, wherein ITNs were washed individually in aluminium bowls according to WHOPES phase II washing protocol (WHO 2013). Nets were washed in 10 litres of tap water having a maximum hardness of 5 dh and containing 2 g/litre of soap (“Savon de Marseille”) at an outdoor ambient temperature between 25° C. and 29° C. Each net was agitated for 3 min, left to soak for 4 min and further agitated for 3 min totalling 10 min for one washing cycle. Agitation was done by stirring the net with a pole at 20 rotations per minute. Rinsing was done twice using clean water (10 litres per rinsing i.e. 20 litres per net). Nets were dried horizontally in the shade and then stored at ambient temperature (27° C.±2° C.) between washes. The interval between washes was informed by the phase 1 determination of the regeneration time (RT) of the actives, done in Tanzania. The time for regeneration of the active ingredients between washes was 1 day for the tested nets in the present invention.

### Insecticidal Activity Tests

Both Susceptible and Resistant strains of Female malaria mosquitoes (Anopheles gambiae) were selected for study, and they were fed with sugared water only.

The tested new formulations products A, B and C developed using unique incorporation technology according to the present invention were tested along with existing WHO Prequalified Market Product. The below table summarized the features of the products under bioefficacy evaluation:

| Tested | | | | Technology | Polymer | |
|---|---|---|---|---|---|---|
| Products | Active | Active | Synergist | used | Matrix | Denier |
| A | Bifenthrin | Chlorfenapyr | Piperonyl | Incorporation | Polyethylene | 120 |
| | | | butoxide | in polymer | | |
| | | | (PBO) | matrix | | |
| B | Bifenthrin | Chlorfenapyr | — | Incorporation | Polyethylene | 120 |
| | | | | in polymer | | |
| | | | | matrix | | |
| C | α-Cypermethrin | Chlorfenapyr | Piperonyl | Incorporation | Polyethylene | 100 |
| | | | butoxide | in polymer | | |
| | | | (PBO) | matrix | | |
| (Q1) WHO | α-Cypermethrin | Chlorfenapyr | — | Coating on | Polyester | 100 |
| Prequalified | (100 mg/m²) | (200 mg/m²) | | fiber/yarn | | |
| Market Product | | | | | | |
| (Coated) | | | | | | |
| (Q2) WHO | α-Cypermethrin | — | Piperonyl | Incorporation | Polyethylene | 130 |
| Prequalified | | | butoxide | in polymer | | |
| Market Product | | | (PBO) | matrix | | |
| (Incorporated) | | | | | | |

Below Tables summarized the outcome of results with respect to WHO threshold criteria for ITNs specifically Blood Feeding Inhibition (BFI) of ≥90% and insects Mortality of ≥80%.

In order to get confidence of data to be generated, the novel formulation of the present inventions were aimed to be tested against different mosquito species viz., Anopheles arabiensis, Anopheles gambiae etc along with both resistant and susceptible strains.

TABLE 1
% Mortality against wild pyrethroid resistant Anopheles arabiensis in Tanzania
% Mortality against wild pyrethroid resistant Anopheles arabiensis in Tanzania

| | 24 Hrs Mortality | | 72 Hrs Mortality | | 120 Hrs Mortality | |
|---|---|---|---|---|---|---|
| Tested | | 20 X | | 20 X | | 20 X |
| Products | Unwashed | washed | Unwashed | washed | Unwashed | washed |
| A | 72 | 57 | 75 | 58 | 76 | 63 |
| B | 75 | 54 | 76 | 55 | 78 | 59 |
| (Q1) WHO | 47 | 34 | 52 | 38 | 54 | 46 |
| Prequalified | | | | | | |
| Market Product | | | | | | |
| (Coated) | | | | | | |

TABLE 2
% Mortality against wild pyrethroid resistant Anopheles gambiae in Ivory Coast
% Mortality against wild pyrethroid resistant Anopheles gambiae sl. in Ivory Coast

| | 24 Hrs Mortality | | 72 Hrs Mortality | | 120 Hrs Mortality | |
|---|---|---|---|---|---|---|
| Tested | | 20 X | | 20 X | | 20 X |
| Products | Unwashed | washed | Unwashed | washed | Unwashed | washed |
| A | 88 | 82 | 89 | 83 | 91 | 84 |
| B | 87 | 79 | 87 | 80 | 88 | 80 |
| (Q1) WHO | 72 | 67 | 73 | 69 | 74 | 70 |
| Prequalified | | | | | | |
| Market Product | | | | | | |
| (Coated) | | | | | | |

TABLE 3
% Mortality against wild pyrethroid resistant Anopheles stephensi in India
% Mortality against wild pyrethroid resistant Anopheles stephensi in India

| | 24 Hrs Mortality | | 72 Hrs Mortality | | 120 Hrs Mortality | |
|---|---|---|---|---|---|---|
| Tested | | 20 X | | 20 X | | 20 X |
| Products | Unwashed | washed | Unwashed | washed | Unwashed | washed |
| C | 90 | 88 | 91 | 87 | 93 | 89 |
| (Q2)WHO | 21 | 25 | 23 | 28 | 26 | 29 |
| Prequalified | | | | | | |
| Market Product | | | | | | |
| (Incorporated) | | | | | | |

All the ITN products (A, B and C) developed based on the incorporated insecticidal composition in polymer matrix of polyethylene as per the present invention showed significantly improved mortality in the pyrethroid resistant Anopheles arabiensis and Anopheles gambiae in comparison to already marketed coated product.

With regard to Blood Feeding Inhibition (BFI) study performed, following is the summary of data generated—

TABLE 4
% Feeding Inhibition against wild pyrethroid
resistant Anopheles arabiensis in Tanzania
% Feeding Inhibition against wild pyrethroid
resistant Anopheles arabiensis Study at Tanzania

| Tested Products | Unwashed | 20 X washed |
|---|---|---|
| A (incorporated) | 91 | 82 |
| B (incorporated) | 86 | 90 |
| (Q1)WHO Prequalified | 91 | 79 |
| Market Product (Coated) | | |

TABLE 5
% Feeding Inhibition against wild pyrethroid
resistant Anopheles gambiae in Ivory Coast
% Feeding Inhibition against wild pyrethroid
resistant Anopheles gambiae in Ivory Coast

| Tested Products | Unwashed | 20 X washed |
|---|---|---|
| A | 80 | 81 |
| B | 77 | 83 |
| (Q1)WHO Prequalified | 67 | 53 |
| Market Product (Coated) | | |

TABLE 6
% Feeding Inhibition against wild pyrethroid
resistant Anopheles stephensi in India
% Feeding Inhibition against wild pyrethroid
resistant Anopheles stephensi in India

| Tested Products | Unwashed | 20 X washed |
|---|---|---|
| C | 86 | 85 |
| (Q2)WHO Prequalified | 35 | 31 |
| Market Product (Incorporated) | | |

All the ITN products (A,B and C) developed based on the incorporated insecticidal composition in polymer matrix of polyethylene as per the present invention showed significantly improved % feeding inhibition under both washed and unwashed condition in the pyrethroid resistant Anopheles arabiensis and Anopheles gambiae in comparison to already marketed WHO Prequalified coated product (Q1 and Q2).

In view to assess the safety (as % Personal protection) of products (A, B and C) developed based on the incorporated insecticidal composition in polymer matrix of polyethylene as per the present invention, an independent study was performed (at Tanzania as well as Ivory Coast) to know the personal protection level of users (human), since it is expected that incorporated products are much safer than coated products being unexposed directly on surface of the monofilament fiber fabric unlike coated filaments.

A comparative study for % personal protection (both under washed and unwashed condition) performed has provided the below data as summarized in table—

TABLE 7
% Personal Protection against wild pyrethroid
resistant Anopheles arabiensis in Tanzania
% Personal Protection against wild pyrethroid
resistant Anopheles arabiensis Study at Tanzania

| Tested Products | Unwashed | 20 X washed |
|---|---|---|
| A | 89 | 79 |
| B | 83 | 89 |
| (Q1) WHO Prequalified | 79 | 27 |
| Market Product (Coated) | | |

TABLE 8
Personal Protection against wild pyrethroid
resistant Anopheles gambiae in Ivory Coast
% Personal Protection_against wild pyrethroid
resistant Anopheles Anopheles gambiae in Ivory Coast

| Tested Products | Unwashed | 20 X washed |
|---|---|---|
| A | 82 | 86 |
| B | 84 | 85 |
| (Q1) WHO Prequalified | 77 | 43 |
| Market Product (Coated) | | |

TABLE 9
% Personal Protection against wild pyrethroid
resistant Anopheles stephensi in India
% Personal Protection_against wild pyrethroid
resistant Anopheles stephensi in India

| Tested Products | Unwashed | 20 X washed |
|---|---|---|
| C | 87 | 89 |
| (Q2) WHO Prequalified | 50 | 57 |
| Market Product (Incorporated) | | |

All the ITN products (A, B and C) developed based on the incorporated insecticidal composition in polymer matrix of polyethylene as per the present invention tested for personal protection owing to assess safety profile, they showed significantly improved % Personal protection under both washed and unwashed condition in the pyrethroid resistant Anopheles arabiensis in comparison to already marketed WHO Prequalified coated product. This showed exceptional confidence on products according the present invention for their usability as safe incorporated ITN product.
While reviewing the data generated compiled in the Table 1, 2, 3, 4, 5, 6, 7, 8 and 9, following may be inferred—
   1. ITN products derived from novel incorporated insecticidal composition in polyethylene polymer matrix appears to be promising in their activities and intended role of controlling disease carrying vectors with mosquitoes or similar insects.
   2. ITN products A, B and C derived from novel incorporated insecticidal composition in polyethylene polymer matrix are enough potent and already exceeding the WHO threshold criteria for ITNs specifically Blood Feeding Inhibition (BFI) of ≥90% and insects Mortality of ≥80%.
   3. ITN products A,B and C derived from novel incorporated insecticidal composition in polyethylene polymer matrix were found significantly superior compared from existing WHO Prequalified Marketed Product, which is an insecticidal coated but not a polymeric matrix incorporated product. Further, said novel incorporated products has better expectations, since highly toxic/hazardous active insecticide/pesticides unlike WHO Prequalified Marketed coated polyester Product, are not present on the surface of fabric (knitted fibers) but present in polymer matrix inside, which not only provides the improved shelf life but also ensure the long term safety from exposure to the user human beings at field and homes.
   4. ITN products A, B and C derived from novel incorporated insecticidal composition in polyethylene polymer matrix are found to be quite safe for human use with significant retention of activity.
   5. ITN products derived from novel incorporated insecticidal composition in polyethylene polymer matrix are observed to apparently more retained active entity in the incorporated polymer matrix based product and quite safe for human use.
   A separate study was also performed independently for understanding the regeneration time after washing following WHO criteria for the ITN products derived from novel incorporated insecticidal composition in polyethylene polymer matrix. Customary tests like Cone Assay and Tunnel tests were performed as per WHO protocol (WHO Threshold criteria of 95% Knock Down in 60 min i.e. KD60 and or 80% 72 hour Mortality for Cone Assay).
   The result outcomes for the ITN products derived from novel incorporated insecticidal composition in polyethylene polymer matrix according to the present invention surprised the finding that all products obtained exceeds the WHO Threshold criteria of for regeneration time. Below table-10 summarized the outcome data—

TABLE 10
Regeneration time of Novel ITN products - using wild pyrethroid resistant
Anopheles arabiensis in Tanzania(A & B) and Anopheles stephensi in India (C)
Regeneration time using whole net (ITN) series method

| | 72 Hrs Mortality | | | | | | | |
|---|---|---|---|---|---|---|---|---|
| | Day (0) | | Day (1) | | Day (5) | | Day (7) | |
| Tested | % | % Feeding | % | % Feeding | % | % Feeding | % | % Feeding |
| Products | Mortality | Inhibition | Mortality | Inhibition | Mortality | Inhibition | Mortality | Inhibition |
| A | 100 | 100 | 100 | 100 | 100 | 100 | 99.4 | 100 |
| B | 100 | 100 | 100 | 100 | 100 | 100 | 100 | 100 |
| C | 100 | 100 | 100 | 100 | 97.5 | 93.0 | 100 | 100 |
| (Q1)WHO | 85.1% | 99.4% | — | — | — | — | — | — |
| Prequalified | | | | | | | | |
| Market Product | | | | | | | | |

It may be inferred from the above, that even after day 1 (after 24 hours) reuse, it indicates exceptional potency and Actives role in the incorporated fabric both in terms of % mortality and % feeding inhibition, though the WHO prequalified market product indicated both % mortality and Feeding inhibition to the lesser even on Day (0).

ITNs products obtained using incorporate insecticidal composition in polymer matrix comprising of a pyrethroid insecticide, a pyrrole chemical entity and/or optionally an organic synergist were found Bio efficacious after 1, 3, 5, 10, 15, and 20 laboratory washes against both the resistant and susceptible strains.

Based on these results, ITNs products A, B and C demonstrated significantly bioefficacious and inline with WHO qualification threshold on both the laboratory-reared resistant strain of Anopheles arabiensis (Kingani strain) and susceptible Anopleles gambiae (Ifakara strain) mosquitoes.

While the foregoing pages provide a detailed description of the preferred embodiments of the invention, it is to be understood that the description and examples are for illustrative purpose only of the principles of the invention and not limiting to its scope. Furthermore, as many changes can be made to the invention without departing from the scope of the invention, it is intended that all material contained herein be interpreted as illustrative of the invention and not in a limiting sense.

1. Incorporated insecticidal composition in polymer matrix comprising of a pyrethroid insecticide, a pyrrole chemical entity and/or optionally an organic synergist effective for controlling disease carrying vectors.

2. Incorporated insecticidal composition in polymer matrix according to claim 1, wherein insecticidal composition is useful for making insect/pests protective nets or insecticide treated nets (ITNs) or long lasting insecticidal net (LLIN).

3. Incorporated insecticidal composition in polymer matrix according to claim 1, wherein, polymer matrix is selected from polyethylene or polypropylene.

4. Incorporated insecticidal composition in polymer matrix according to claim 1, wherein, pyrethroid insecticide is selected from Bifenthrin, lambda-Cyhalothrin, alpha Cypermethrin or Deltamethrin and said pyrrole chemical entity is Chlorfenapyr and said organic synergist is Piperonyl butoxide (PBO) or o-cresol derivatives.

5. Incorporated insecticidal composition in polymer matrix according to claim 1, wherein the insecticide treated nets (ITNs) or long lasting insecticidal net (LLIN) is produced out by warp knitting from monofilament yarn extruded out of this polymer matrix.

6. Incorporated insecticidal composition in polymer matrix according to claim 1, wherein monofilament yarn produced has linear density ranging between 75 to 200 denier.

7. The method of incorporating the insecticidal composition in polymer matrix comprising the steps—
a. mixing the pyrethroid insecticide, a pyrrole entity and an organic synergist each individually or in combination in the polymer matrix in the melt stage in twin screw compounding extruder;
b. recovering the master batch granules incorporated with insecticide composition;
c. testing the master batch for incorporated insecticide content, wherein the concentration of pyrethroid insecticide is in range of 5% to 20% w/w, the concentration of pyrrole insecticide as Chlorfenapyr is in the range of 5% to 20% w/w and the concentration of organic synergist as Piperonyl butoxide is in the range of 0% to 10% w/w.

8. The method of incorporating the insecticidal composition in polymer matrix according to claim 7, wherein the step a. comprising mixing the pyrethroid insecticide, a pyrrole entity and an organic synergist each individually providing individual master batch granules.

9. The method of incorporating the insecticidal composition in polymer matrix according to claim 7, wherein the step a. comprising mixing insecticide optionally with adjuvant selected from antioxidants, UV Stabilizers/absorbers, processing aids, coloring agents, release agents, lubricants, surfactants, antistatic agents and viscosity modifiers or adjuvant can be incorporated within polymer matrix separately without combining with insecticide/s.

10. The method of incorporating the insecticidal composition in polymer matrix according to claim 7, wherein step b of recovering master batch granules comprising cutting and flash cooling at temperature ranging between 10-20° C.

11. Incorporated insecticidal composition in polymer matrix according to claim 7, wherein insecticide treated nets (ITNs) or long lasting insecticidal net (LLIN), using incorporation of insecticidal composition is achieved during extrusion process in the direct master batch mixing or molten state of the polymer matrix using side feeder.
